(19) United States
(12) Patent Application Publication
(10) Pub. No.: US 2025/0331095 A1
(43) Pub. Date: Oct. 23, 2025

(54) LINEAR ACCELERATOR SYSTEM

(71) Applicant: UNIVERSITY OF LANCASTER, Lancashire (GB)

(72) Inventors: Graeme Burt, Lancashire (GB); Samuel Smith, Lancashire (GB)

(21) Appl. No.: 18/866,870

(22) PCT Filed: May 18, 2023
(86) PCT No.: PCT/GB2023/051310

§ 371 Date: Nov. 18, 2024

(30) Foreign Application Priority Data
May 20, 2022 (GB) 2207412.4

(51) Int. Cl. H05H 7/06; H05H 7/02; H05H 7/22

(52) U.S. Cl. CPC H05H 7/06; H05H 7/02; H05H 7/22

(57) ABSTRACT

A multifrequency linear accelerator system (100) which can be used to generate multidirectional particle beams (101. 102) for, e.g., multidimensional radiotherapy and X-ray imaging is described. The system (100) comprises an electromagnetic ‘EM’ source (104), a first linear accelerator (106) operable at a first frequency, a second linear accelerator (108) operable at a second, different, frequency, a first circulator (110) and a second circulator (112). The first linear accelerator (106) is arranged to received EM power (118) supplied from the EM source at the first frequency via the first circulator (110), and the second linear accelerator (108) is arranged to receive EM power (120) supplied by the EM source at the second frequency via the first circulator (110) and the second circulator (112).

### FIELD OF THE INVENTION

The present disclosure relates to a multifrequency linear accelerator system, and in particular to a technique for fast switching electromagnetic pulses to different linear accelerators at different times for the generation of X-rays. The present disclosure is particularly concerned with small scale accelerators for use in medical and cargo imaging.

### BACKGROUND

X-ray generation is a useful tool with broad ranging applications. For example, X-rays are used in cargo scanning at travel hubs such as airports, ports, and stations, they are used in hospitals to image patients, and in some instances they can also be used in medical treatments.

One device which can be used for the generation of X-rays is the linear accelerator, or linac. Here a linac is used to create a beam of high energy electrons (e.g. 4 to 25 mega electron Volts ‘MeV’), and those high energy electrons then used to generate X-rays via impact on a high-density material target (such as tungsten). Alternatively, the electron beam from the linac can be used directly for procedures such as electron beam radiotherapy.

For some applications it can be desirable to generate X-rays (or indeed an electron beam) from multiple directions, e.g., in order to provide images from different diagnostic angles.

Existing techniques for achieving multi-directional scanning often have a single X-ray generator (or more broadly, a single piece of scanning equipment) physically moved from one position to another around the patient/object in order to scan a different angle. Alternatively, it is often easier to simply change the orientation of the object/patient being scanned whilst leaving the X-ray scanner in a fixed position. Such approaches are simple but take time, and often add delay between diagnostic images which is not always desirable.

Another technique involves arranging a number of separate units to generate X-rays from each of the desired directions (and may be configured to do so simultaneously). A drawback of such an approach however is that each X-ray generator (i.e., linac) must have its own power supply and amplification components, which significantly increases the cost of the overall device and the space which it requires (consider that space is often at a premium in hospitals).

Hence an alternative system for multi-directional X-ray scanning (and/or electron beam therapy) is highly desirable.

### SUMMARY

The present invention is defined according to the independent claims. Additional features will be appreciated from the dependent claims and the description herein. Any embodiments which are described but which do not fall within the scope of the claims are to be interpreted merely as examples useful for a better understanding of the invention.

The example embodiments have been provided with a view to addressing at least some of the difficulties that are encountered with current X-ray generators, whether those difficulties have been specifically mentioned above or will otherwise be appreciated from the discussion herein.

Accordingly, in one aspect of the invention there is provided a multifrequency linear accelerator system. The system comprises an electromagnetic ‘EM’ source, a first linear accelerator operable at a first frequency, a second linear accelerator operable at a second, different, frequency, a first circulator, and a second circulator. The first linear accelerator is disposed (i.e., arranged) to received EM power supplied from the EM source at the first frequency via the first circulator, and the second linear accelerator is disposed (i.e., arranged) to receive EM power supplied by the EM source at the second frequency via the first circulator and the second circulator.

In this way particle beams (preferably electrons) for use in e.g. radiotherapy and/or X-ray imaging can be supplied by the linear accelerators from two different directions using a single power source; in this case typically desired directions will be ones which are orthogonal on a two-dimensional plane.

In a preferred arrangement of the system a third linear accelerator is provided which is operable at a third frequency different to both the first and second frequencies. The third linear accelerator is disposed (i.e., arranged) to receive EM power supplied from the EM source at the third frequency via the first circulator, the second circulator, and a third circulator. Suitably three particle beams may be generated which is particularly useful for 3-dimensional imaging and/or 3-dimensional radiotherapy purposes. Typically the three directions will be orthogonal to each other.

Beneficially, the linear accelerators can be stimulated substantially simultaneously or sequentially depending on the configuration of the single power source. In one example the EM source may be configured to transmit EM power at the first frequency, second frequency and where appropriate power at the third frequency as separate EM pulses. The order of the pulse generation and time delay between pulses may be varied to change the sequence of linac power, as desired. In another example the EM source may be configured to transmit EM power at the first frequency, second frequency, and optionally third frequency as part of a single EM pulse. Combinations of two frequencies in a single pulse and a third (and indeed possibly further) frequency as a separate pulse are also possible.

In some examples, it is desirable to include a (first) filter disposed between the first circulator and first linear accelerator, and optionally a (second) filter disposed between the second circulator and the second linear accelerator. Here the first filter is configured to transmit EM power at the first frequency and reflect EM power at the second frequency, and the second filter configured to transmit EM power at the second frequency and reflect other frequencies (e.g., power at the third frequency). Similarly, a (third) filter configured to transmit power at the third frequency may be included between the between the third circulator and the third linear accelerator. Such an arrangement is particularly beneficial when there is operating frequency overlaps between the various linear accelerators with filters being provided as required depending on exactly which accelerators have overlapping operation frequency.

In another aspect of the invention there is provided an X-ray imaging apparatus comprising the aforementioned system, and a radiotherapy device comprising the aforementioned system.

### BRIEF DESCRIPTION OF THE DRAWINGS

For a better understanding of the present disclosure reference will now be made by way of example only to the accompanying drawings, in which:

FIG. 1 shows a schematic diagram of an example multifrequency linac system with two linacs;

FIG. 2 shows a schematic diagram of an exemplary multifrequency linac system with three linacs; and

FIG. 3 shows a schematic diagram of an exemplary multifrequency linac system as part of an X-ray imaging device (FIG. 3A) and a radiotherapy device (FIG. 3B);

FIG. 4 shows example operating frequencies for different linacs in an example multifrequency linac system;

FIG. 5 shows a comparison between unfiltered (FIG. 5A) and filtered (FIG. 5B) operation of an example multifrequency linac system.

### DETAILED DESCRIPTION

As will be familiar to those in the art, a linear particle accelerator (hereafter shortened to linac) is a type of particle accelerator that accelerates charged particles to a high speed by subjecting them to a series of oscillating electric potentials along a beamline. The general operation of a linac is well known in the art and so not explored in detail here.

The linacs which are the focus of the present disclosure are those which accelerate electrons, as it is electron linacs which are most commonly used in medical and cargo imaging applications. A typical electron beam energy for the linacs of the present disclosure might be between 4 and 25 MeV, as is often used in medical applications. In principle however the present techniques may also be applied to linacs accelerating other charged particles; for example a proton beam with energy in the range of 200-250 MeV, as is typically used in proton beam therapy.

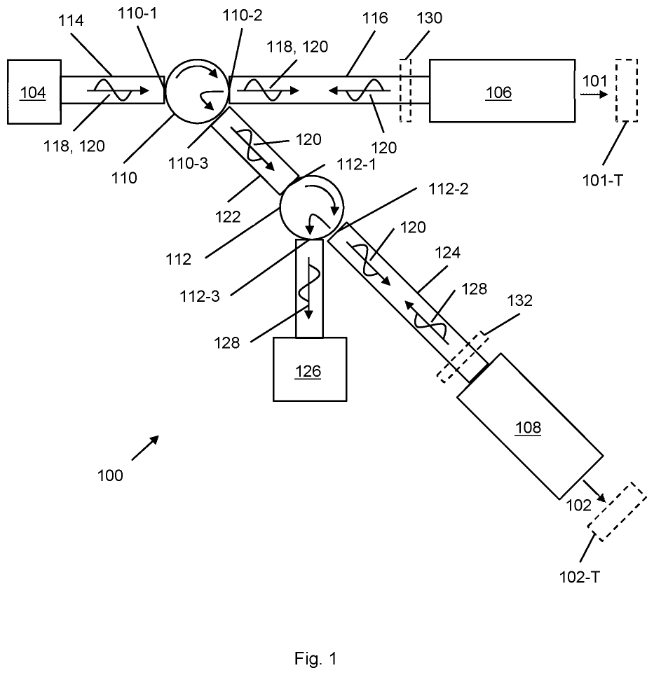

FIG. 1 shows a schematic diagram of an example multifrequency linac system 100. The system 100 is suitably configurable to generate two separate electron beams 101 & 102 from two different directions. The electron beams 101, 102 may be used for the generation of X-rays (e.g., via impact on a high-density target 101-T, 102-T) or used directly by e.g., radiotherapy.

In the illustrated schematic the two directions have a common component (e.g. both having a component of travel/direction toward the right of the page). However, this is only exemplary, and it will be readily appreciated that other configurations are possible. For example, in a preferred arrangement of a two-beam system, the system 100 may be suitably configured to provide electron beams 101, 102 in orthogonal directions on a two-dimensional plane-e.g., an x and y axis is a typical cartesian coordinate system.

The system 100 comprises an electromagnetic ‘EM’ power source 104 configured to supply electromagnetic power for a linear accelerator; that is, a power source of the sort that is typically used to power linacs used in medical and/or cargo scanning equipment. Suitably the EM power source 104 is configured to supply one or more radio frequency EM pulses which are utilised by one or more linacs in the system 100 for accelerating electrons.

Here the system 100 comprises a first linear accelerator 106 and a second linear accelerator 108 (in order to provide the two (electron) beam directions 101, 102). The first linear accelerator 106 is operable at a first frequency while the second linear accelerator 108 is operable at a second frequency. In this context, “operable” at a given frequency means that the respective linac 106, 108 can utilise EM power at that frequency in the process of accelerating electrons to generate an electron beam. Also in the context of the present discussion, the first frequency and second frequency may be taken to be the resonant frequencies of the respective linacs. It will however be appreciated that, in practice, the first linac and second linac will operate on a range of frequencies about (e.g., centred on) the first frequency and second frequency.

The frequencies of operation (i.e. the first and second frequency) are different, so that EM power supplied from the source 104 at the first frequency stimulates the first linac 106 (but not necessarily the second linac 108), and similarly EM power supplied at the second frequency stimulates the second linac 108 but not the first linac 106. Put another way, the first linac 106 absorbs EM power supplied at the first frequency, and rejects other frequency EM power, while the second linac 108 absorbs EM power supplied at the second frequency, and similarly rejects EM power at other frequencies. EM power that is rejected from a linac (i.e., not absorbed) is reflected from that linac back along the direction at which it was transmitted to the linac.

To route the supplied EM power to the respective linacs 106, 108, the system 100 comprises a first circulator 110 and a second circulator 112. As will be familiar to those in the art, a circulator is a multi-port device which transmits inputs to the device in a single direction (clockwise in the present figures). For example, for a three-port device, a signal input to port 1 is transmitted to port 2 and isolated from port 3, a signal input at port 2 is transmitted to port 3 and isolated from port 1, and a signal input at port 3 is transmitted to port 1 and isolated from port 2. Beneficially, circulators are typically designed to have minimal loss when transmitting an input signal from one port to the next.

Preferably the circulators utilised in the present disclosure are of the three-port variety configured as an asymmetrical Y-type junction of three identical waveguides with an axially magnetized (by a static B field) ferrite post placed at the centre. Three-port circulators have generally more consistent (and so better) performance compared to four-port varieties, and are therefore preferred for the present purposes.

The first circulator 110 is positioned in the system 100 in between the EM power source 104 and first linac 106, so that the first linac 106 receives power supplied from the source 104 via the first circulator 110.

More specifically, the EM power source 104 is coupled to a first port 110-1 of the first circulator 110 by a transmission line 114, and the first linac 106 is coupled to a second port 110-2 of the first circulator 110 by a transmission line 116, and the transmission lines 114, 116 are coupled by sequential ports 1 & 2 of the first circulator 110. Thus a pulse comprising first power 118 at the first frequency travels along the transmission line 114, enters the first port 110-1 of the first circulator, exits the second port 110-2 of the first circulator, and travels along transmission line 116 to the first linac 106 where it then stimulates acceleration at the first linac 106.

The second circulator 112 is arranged in the system 100 in between the first circulator 110 and the second linac 108, such that the second linac 108 receives (second) EM power 120 supplied at the second frequency via the first circulator 110 and second circulator 112.

More specifically, a third port 110-3 of the first circulator is coupled to a first port 112-1 of the second circulator by a transmission line 122, while the second linac 108 is coupled to a second port 112-2 of the second circulator by a transmission line 124; the first and second ports 112-1, 112-2 are sequential such that the second circulator 112 couples the transmission lines 122, 124.

The second EM power 120 supplied at the second frequency will initially follow the same transmission path above as the first power 118 supplied at the first frequency, but does not terminate at the first linac 106. Instead, the second EM power 120 reflects from the first linac 106 to return back down the transmission line 116 and into the port 110-2 of the first circulator. The second EM power 120 then exits the third port 110-3 of the first circulator, travels along transmission line 122 to the first input port 112-1 of the second circulator, exits the second circulator by the second port 112-2, and travels along transmission line 124 to the second linac 108 where the second EM power 120 then stimulates acceleration in that linac.

In the present example, a third port 112-3 of the second circulator is suitably coupled to a load 126 which absorbs any EM power supplied by the power source 104 which is reflected by both the first linac 106 and second linac 108 (i.e., any RF frequency which is not suitably close to the resonant frequencies of the two linacs in the system 100). That is, EM power 128 reflected form the second linac 108 travels back along the transmission line 124 into the second circulator 112 by the second port 112-2, exits the second circulator 112 by the third port 112-3 to the load 126.

It will be appreciated that, advantageously, the multifrequency linac system 100 requires only a single EM power source 104 to operate. The frequency separation of the linacs selects which pulse supplied by the power source 104 activates which linac 106, 108. Moreover, the arrangement of circulators 110, 112 not only routes the EM power to the respective linacs, but also ensures that EM power rejected by the linacs cannot travel back along the system to the power source 104 (which could damage the power source 104).

Suitably the EM power may be supplied from the EM source 104 in the form of one or more EM pulses. In one example the EM source 104 is configured to generate a first pulse and a second pulse corresponding to the first linac 106 and second linac 108, and to transmit those pulses sequentially for routing through the system 100 to the respective linac 106, 108. The choice of which pulse to generate and transmit first may be varied depending on which linac it is desired to stimulate first according to the desired usage of the system 100. For example, in the illustrated system whereby the transmission path from the source 104 to the second linac 108 is longer than the transmission path to the first linac 106, EM power for the second linac 108 may be generated and transmitted first and EM power for the first linac generated and transmitted second after a suitable time delay; in this way the linacs could be stimulated in order or second linac 108 then first linac 106, or even substantially simultaneously.

In another example a single pulse may be generated which comprises frequency steps corresponding to the first frequency and second frequency. As only a single pulse is used, timing control of the system (i.e., which linac is stimulated first) is controlled by the length of the respective transmission paths to the respective linacs and not the EM power source 104; it should however be appreciated that simultaneously stimulation of the linacs cannot be achieved due to the pulse necessarily reflecting off the first linac 106 before reaching the second linac 108.

In some example implementations, the frequency of operation of the first linac 106 and second linac 108 may overlap, such that EM power supplied with the intent of powering one of the linacs may also power the other linac. While the first and second resonant frequencies are still different between the two linacs, in multi-cell cavities there may be multiple unwanted modes that could potentially be excited by accident, particularly if there is some overlap in the range of frequencies about the first and second frequency on which both linacs may operate. The problem here is that the second linac 108 will not receive as much power as intended, or possibly even required, for it to operate (due to some power being absorbed by the first linac 106), depending on the exact amount of frequency overlap.

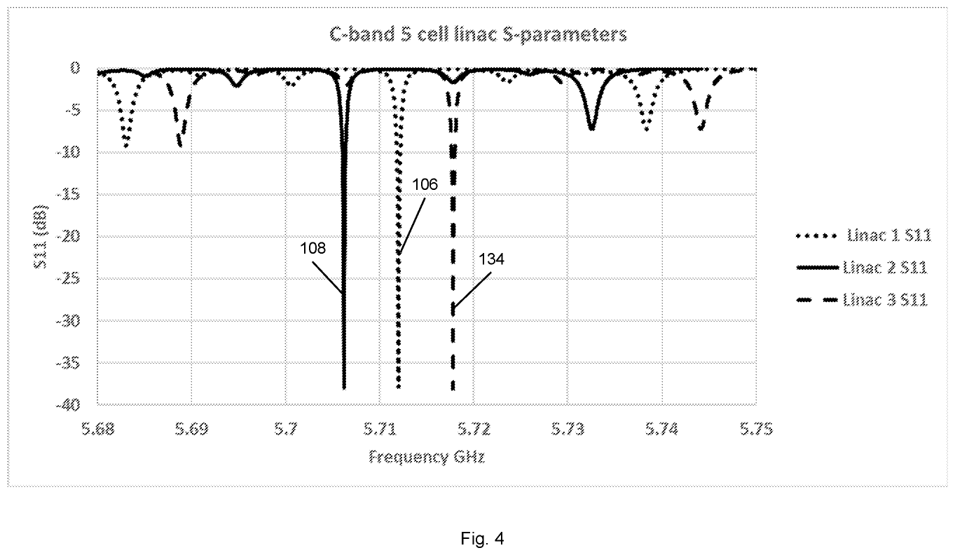

FIG. 4 shows example operating frequencies for a first linac 106 and second linac 108 in an example system, whereby eigenmodes for exciting each linac cavity are separated by 6 MHz (also shown is frequency for a third linac 134, discussed later). However, existing linacs to which the present system may be adapted may have much closer spacing in frequency separation. The separation between working frequencies is limited by the bandwidth of the RF amplifier making the likelihood of exciting an unwanted mode higher as this is likely to be less than the separation between the first and last eigenmode; which is typically less than 10 MHz.

Accordingly, the system 100 may optionally include (cavity) filters before the linacs which act as transmitters or reflectors for certain frequencies, so that each linac only sees one frequency and not all frequencies. More specifically, in the present example, the system 100 may comprise at least a first filter 130 in between the first circulator 110 and the first linac. The first filter 130 is suitably configured to transmit the first EM power 118 at the first frequency and reflect the second EM power 120 at the second frequency.

It will be appreciated that the filter 130 may also be used in systems even without operating frequency overlap between the first and second linacs 106, 108. This may be beneficial in order to better control (e.g., restrict to a narrower range) the EM power 118 entering the first linac 106. This may be helpful where, e.g., operation of the linac 106 is negatively impacted by frequencies far away from the resonance frequency but which still propagate through the linac.

Suitably the system 100 may also include a second filter 132 to provide power control to the second linac 108. Suitably the second filter may be arranged in between the second circulator 112 and second linac 108 and configured to transmit the second EM power 120 (while reflecting other frequencies). A second filter 132 may also be desirable when the system is upscaled to include further linacs (see below).

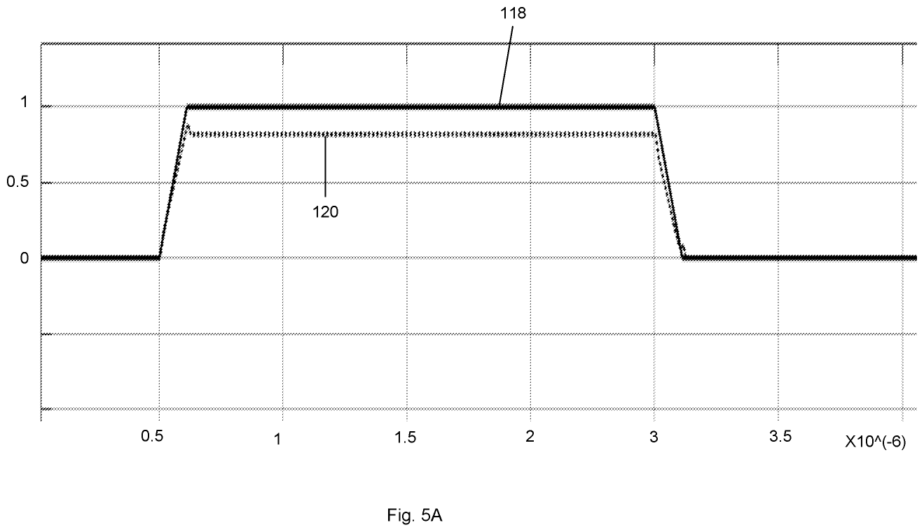

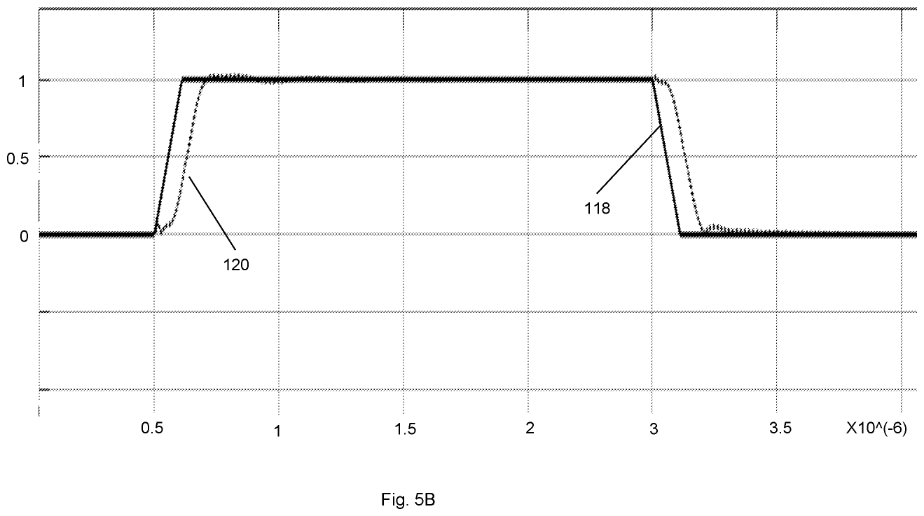

FIG. 5 shows an example comparison between a system 100 comprising in an unfiltered operating regime (FIG. 5A) and a filtered operating regime (FIG. 5B). More specifically, FIG. 5A shows example of normalised frequency received at the first linac 106 and second linac 108 in a system 100 which does not comprise a first filter 130 (or second filter 132), whereas FIG. 5B shows the same in a system 100 which comprises at least a first filter 130. The resonant frequencies of the respective linacs correspond to those of FIG. 4.

As can be seen in FIG. 5A, the first EM power pulse 118 is received into the first linac 106 at full power (i.e., normalised to 1), whereas the second EM power pulse 120 is received into the second linac 108 at only 80% of the originally transmitted power. That is, the second pulse 120 has suffered a 20% reduction in power due to part absorption by the first linac 106.

By contrast, as seen in FIG. 5B, by introducing the first filter 130, all of the second transmitted power 120 is transferred to the second linac 108, as none of the second pulse 120 can be absorbed by the first linac.

The filters 130, 132 may be single cell cavities, as will be known to those in the art. Preferably, the filters 130, 132 are narrow band in order to select only one of the frequencies from EM power source 104. Suitably, each filter may be a single stage cavity filter, as these devices have a single narrow transmission band. In a preferred configuration, the filters 130, 132 are configured with a bandwidth at least double the bandwidth of the respective linac cavity; for example, the filter bandwidth may be the order of 1 MHz. Further preferable, the filters 130, 132 may be configured to operate in a low loss mode, such as the TE01 mode.

The use of a narrowband filter also allows the same scheme to be used to drive multiple broadband travelling wave linacs, which without a filter would accept all frequencies with minimal reflection. Such a system is particularly advantageous in radiotherapy application in order to avoid use of rotating a linac.

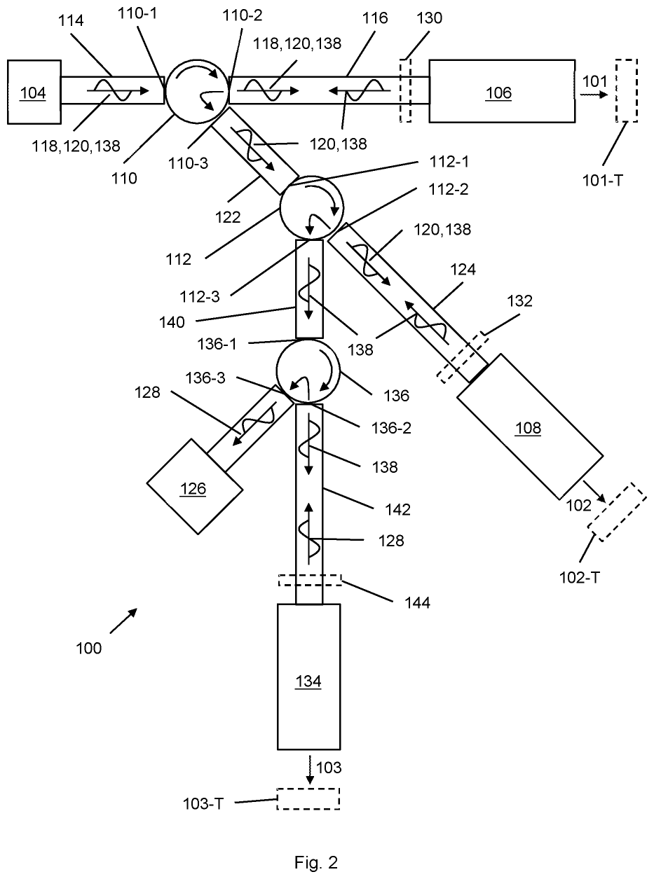

FIG. 2 shows a schematic diagram of another example multifrequency linac system 100′, here with three linacs, as an example of scaling up the previous teachings to involve further linacs to provide further multidirectional electron beam generation. The system 100′ is also particularly advantageous for providing a system which allows for three-dimensional scanning (i.e., via a third electron beam direction 103 and e.g., X-ray generating target 103-T). In particular, the system 100′ may be suitably arranged to provide an electron beam from three orthogonal directions—e.g., along x, y, and z axes in a typical cartesian coordinate system.

The system 100′ of FIG. 2 builds upon the teachings of FIG. 1, such that the interactions of the first linac 106, second linac 108, first circulator 110 and second circulator 112 are as previously described. In addition, the example of FIG. 2 also comprises a third linac 134 and a third circulator 136. The third linac 134 operates at a different frequency to both the first linac 106 and second linac 108 (as shown in e.g., FIG. 4), and receives EM power from the source 104 via the first circulator 110, second circulator 112, and third circulator 136.

More specifically, a first port 136-1 of the third circulator is coupled to the third port 112-2 of the second circulator, a second port 136-2 of the third circulator is coupled to the third linac 134, and a third port 136-3 of the third circulator is coupled to the load 126.

Thus, EM power 138 supplied at the third frequency travels through the system 100′ alongside to the second linac 108 as described for the second power 120. The third EM power 138 is reflected from the second linac 108 to travel back down the transmission line 124 into the second port 112-2 of the second circulator. The third power 138 exits the second circulator 112 by the third port 112-3 and travels along transmission line 140 to a first port 136-1 of the third circulator 136. The third power 138 exits the third circulator 136 by the second port 136-2 and travels along transmission line 142 to the third linac 134. Here the third power 138 is received into the third linac 134 to stimulate acceleration of electron beam 103.

Similar to as described with reference to FIG. 1, EM power 128 which is not at the third frequency (or the first or second frequencies for that matter) will be reflected from the third linac 134 and travel back along transmission line 142 to the second port 136-2 of the third circulator. The excess power 128 exits the third circulator 136 by the third port 136-3 and travels to the load 126. Also following the discussion of FIG. 1, the third EM power 138 may be supplied as a separate pulse to the first and second powers 118, 120 or part of the same pulse. It will however be appreciated that the pulse generation may be suitably varied for the desired circumstances. For example generating the first and second power 118, 120 as a single pulse and the third power 138 as a separate pulse, or a different combination of two of the three powers in a single pulse and the remaining power as a separate pulse.

As already discussed in relation to FIG. 1, it is possible that there is some overlap in the frequency of operation of the first, second and third linacs 106, 108, 134. Thus, the first filter 130 may further reflect the EM power 138 at the third frequency (if there is some frequency overlap between the first linac 106 and third linac 134), and so too may the second filter 132 (if there is some frequency overlap between the second linac 108 and third linac 134). A third filter 144 may also be provided in between the third circulator 136 and the third linac 134 which may be suitably configured to transmit power at the third frequency (and optionally a range thereabouts) and reflect other frequencies, if desired, in order to control the EM power entering the third linac 144.

In essence, it will be appreciated that the system 100′ of FIG. 2 represents an upscaling of the system 100 of FIG. 1 from a system of N linacs to a system of N+1 linacs (i.e., N=2 in FIGS. 1 & 2). Thus, in general, a system of N+1 linacs may be formed by changing the third port coupling of the Nth circulator from the load 126 (as it would be in the N linac system) to coupling instead to the first port of the N+1th circulator (in the N+1 linac system), coupling the N+1th linac to the second port of the N+1th circulator, and coupling the third port of the N+1th circulator to the load 126.

In summary, a multifrequency linac system which can be used to generate multidirectional particle beams for, e.g., multidimensional radiotherapy and X-ray imaging has been described. Beneficially the multidirectional beams are generated from a single power source, yielding significant advantages due to the ability to provide a simplified apparatus where multidirectional X-rays and/or beams are required—e.g., in terms of device footprint and complexity of maintenance.

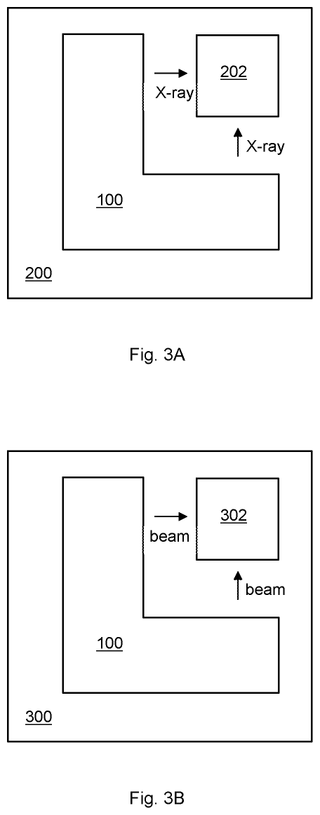

FIG. 3 shows a schematic diagram of such uses. FIG. 3A shows the example system 100 (or system 100′) in use as part of an X-ray imaging apparatus 200 for e.g., cargo or medical scanning of a target 202, while FIG. 3B shows a radiotherapy device 300 incorporating the system 100 (or system 100′) for treating a patient 302.

Additionally, the described exemplary embodiments are convenient to manufacture and straightforward to use. The described multifrequency linac system may be manufactured industrially; an industrial application of the example embodiments will be clear from the discussion herein.

Although preferred embodiment(s) of the present invention have been shown and described, it will be appreciated by those skilled in the art that changes may be made without departing from the scope of the invention as defined in the claims.

Attention is directed to all papers and documents which are filed concurrently with or previous to this specification in connection with this application and which are open to public inspection with this specification, and the contents of all such papers and documents are incorporated herein by reference.

All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification, or to any novel one, or any novel combination, of the steps of any method or process so disclosed.

1. A multifrequency linear accelerator system, comprising:
an electromagnetic ‘EM’ source configured to supply EM power for a linear accelerator;
a first linear accelerator operable at a first frequency;
a second linear accelerator operable at a second frequency different to the first frequency;
a first circulator; and
a second circulator;
wherein the first linear accelerator is disposed to received EM power supplied from the EM source at the first frequency via the first circulator, and
the second linear accelerator is disposed to receive EM power supplied by the EM source at the second frequency via the first circulator and the second circulator.

2. The system of claim 1, wherein the EM source is configured to transmit EM power at the first frequency and EM power at the second frequency as separate EM pulses.

3. The system of claim 1, wherein the EM source is configured to transmit EM power at the first frequency and EM power at the second frequency as part of a single EM pulse.

4. The system of claim 1, wherein the first circulator is a three-port circulator.

5. The system of claim 1, wherein the second circulator is a three-port circulator.

6. The system of claim 1, further comprising a filter between the first circulator and first linear accelerator configured to transmit EM power at the first frequency and reflect EM power at the second frequency.

7. The system of claim 1, further comprising a filter between the second circulator and the second linear accelerator configured to transmit EM power at the second frequency.

8. The system of claim 1, wherein the first linear accelerator and second linear accelerator are arranged to generate orthogonal particle beams.

9. The system of claim 1, further comprising a third linear accelerator operable at a third frequency different to both the first and second frequencies, and wherein the third linear accelerator is arranged to receive EM power supplied from the EM source at the third frequency via the first circulator, the second circulator, and a third circulator.

10. The system of claim 9, wherein the third circulator is a three-port circulator.

11. The system of claim 9, further comprising a filter between the third circulator and the third linear accelerator configured to transmit EM power at the third frequency.

12. The system of claim 11, further comprising a filter between the second circulator and the second linear accelerator configured to transmit EM power at the second frequency, wherein the filter between the second circulator and the second linear accelerator is further configured to reflect EM power at the third frequency.

13. The system of claim 11, further comprising a filter between the first circulator and first linear accelerator configured to transmit EM power at the first frequency and reflect EM power at the second frequency, wherein the filter between the first circulator and first linear accelerator is further configured to reflect EM power at the third frequency.

14. The system of claim 1, wherein the third linear accelerator is arranged to generate a particle beam orthogonal to a plane in which the first and second linear accelerator generate particle beams.

15. The system of claim 1, further comprising a load arranged to receive, via each of the circulators in the system, EM power rejected from all of the linear accelerators.

16. An X-ray imaging apparatus comprising the multifrequency linear accelerator system of claim 1.

17. A radiotherapy apparatus comprising the multifrequency linear accelerator system of claim 1.
